(19) United States
(12) Patent Application Publication
(10) Pub. No.: US 2026/0356024 A1
(43) Pub. Date: Nov. 12, 2026

(54) METHOD FOR CO-EXTRUDING A STARCH WITH AN ACID AND A GLYOXAL-CONTAINING CROSS-LINKING AGENT

(71) Applicant: AGRANA BETEILIGUNGS-AKTIENGESELLSCHAFT, Wien (AT)

(72) Inventors: Bernhard SEIDL, Tulln (AT); Markus SCHUSTER, Tulln (AT)

(21) Appl. No.: 19/473,383

(22) PCT Filed: Apr. 4, 2024
(86) PCT No.: PCT/EP2024/059247

§ 371 Date: Oct. 7, 2025

(30) Foreign Application Priority Data
Apr. 7, 2023 (EP) 23167186.8

(51) Int. Cl. B29C 48/16; B29K 105/24; C08K 3/26; C08K 3/30; C08K 3/32; C08K 5/05; C08K 5/07; C08K 5/092; C09D 7/43; C09D 7/61; C09D 103/02; C09J 11/04; C09J 103/02

(52) U.S. Cl. CPC B29C 48/16; C08K 3/26; C08K 3/30; C08K 3/32; C08K 5/05; C08K 5/07; C08K 5/092; C09D 7/43; C09D 7/61; C09D 103/02; C09J 11/04; C09J 103/02; B29C 2948/922; B29C 2948/92209; B29K 2003/00; B29K 2105/24; C08K 2003/265; C08K 2003/3045; C08K 2003/309; C08K 2003/329

(57) ABSTRACT

The invention relates to a method for producing a starch product, comprising the steps of: (a) providing a starch, and (b) co-extruding the starch with (i) an acid and/or a salt of an acid, and (ii) a glyoxal-containing cross-linking agent to obtain a starch product, characterized in that the acid or the salt of the acid comprises a pKa of 2.7 or below, and in that the amount of the glyoxal-containing cross-linking agent is in the range of 0.1 to 5.0 % by weight, based on the weight of the starch and a starch product obtainable by the method according to the invention.

The present application is a U.S. National Phase of International Application No. PCT/EP2024/059247 entitled “METHOD FOR COEXTRUDING A STARCH COMPRISING AN ACID AND A GLYOXAL-CONTAINING CROSSLINKER”, and filed on Apr. 4, 2024. International Application No. PCT/EP2024/059247 claims priority to European Patent Application No. 23167186.8 filed on Apr. 7, 2023. The entire contents of each of the above-listed applications are hereby incorporated by reference for all purposes.

The present invention relates to a method for producing a starch product, comprising the steps of:
(a) providing a starch, and
(b) co-extruding the starch with (i) an acid and/or a salt of an acid, and (ii) a glyoxal-containing cross-linking agent to obtain a starch product.

By adding acids to starches, the latter can be hydrolyzed and thereby degraded. Acids can also be used as plasticizers for starches. To stabilize the viscosity of the starches during and after their degradation, it is known in the prior art to add a cross-linking agent.

For example, WO 2016/097149 A1 describes a method for destructuring starches, in which an organic acid can be added as a depolymerizing agent in an amount of 0.1 to 10% by weight, based on the amount of starch. As a cross-linking agent, glyoxal can be added in an amount of 0.1 to 5% by weight, also based on the amount of starch. The destructured starch obtained can be added to elastomer mixtures to reduce hysteresis.

EP 2 370 503 A1 discloses the preparation of a bio latex conjugate composition, wherein starch, a plasticizer (e.g. citric acid) and an additive are added to an extruder. Shearing produces a biopolymer additive complex to which a cross-linking agent (e.g. glyoxal) is added in a zone of the extruder downstream of one of the feed zones. The cross-linking agent can prevent the biolatex conjugate composition from dissolving when dispersed in water.

CN 103 467 609 A describes the production of a nano-carboxymethyl starch, wherein a mixture of starch, a plasticizer, monochloroacetic acid and an alkalizing agent is fed to an extruder. A cross-linking agent (e.g. glyoxal) is then added to the extruder for co-extrusion with this mixture.

EP 0 087 847 A1 discloses the production of cold-soluble starch powders for the food industry, wherein starch is extruded with a blowing agent. As a blowing agent, an organic or an inorganic acid can be added in an amount of 0.01 to 10% by weight, based on the amount of starch. To modify the starch, a cross-linking agent, such as glyoxal, can also be added during extrusion in order to improve the water resistance of the starch powder.

CN 103 924 480 A relates to a method in the papermaking industry. A “functional reinforcing agent” is used, which contains 40-60% by weight of starch, 5-30% by weight of a charge modifier, 1-20% by weight of grafting agent, 1-15% by weight of cross-linking agent, 1-8% by weight of sodium hydroxide and 1-3% by weight of acid. In CN 103 924 480 A, however, no reference is made to the use of glyoxal as a cross-linking agent, of all things, nor to the provision of a cross-linking agent amount in the range of 0.1-5.0% by weight (based on the weight of the starch).

WO 00/69916 A1 relates to a method for producing biopolymer nanoparticles, in particular starch nanoparticles, wherein a composition comprising starch and a cross-linking agent (such as glyoxal) is co-extruded.

US 2004/149165 A1 discloses a starch composition from which thermoplastic fibers are subsequently prepared, the composition containing 50-75% by weight of a modified starch, 0.1-10% by weight of an aldehyde cross-linking agent, and 25-50% by weight of water; furthermore, an acid catalyst may be included to adjust a pH of 1.5-5.0. In this document, however, no co-extrusion of the starch with a glyoxal-containing cross-linking agent and the acid takes place, but the compositions are prepared in a beaker by stirring at elevated temperature.

CN 104 031 583 A relates to a method for producing a biopolymer binder for coating a paper, wherein an aqueous solution containing an initiator is first prepared. Thereafter, the starch is mixed with the solution and the temperature is raised to 60-80 °C, whereupon the previously obtained hydrogen peroxide is mixed with the starch and sulfuric acid. Aqueous initiator solution and a cationic monomer and a silane are then added to the resulting product at 70-90 °C. Finally, a cross-linking agent is added, after which it is cooled to 25 °C and a neutralizing agent is added to obtain the polymer. Also according to this method, no co-extrusion of the starch with the one cross-linking agent and an acid is disclosed.

The starch products obtainable by the methods known in the prior art have high viscosity, poor viscosity stability and/or poor solubility, which is disadvantageous in terms of application technology. There is therefore a need for starch products with improved application properties. An object of the present invention is to alleviate or eliminate at least some of these disadvantages of the prior art and to provide an improved starch product. Preferably, a starch product improved in this way should have the highest possible solubility and/or a low viscosity and/or a good viscosity stability and/or few or no nanoparticles (in the range of <1000 nm).

Accordingly, the present invention relates to a method mentioned at the outset, in which the acid or the salt of the acid comprises a pKa of 2.7 or below, and wherein the amount of the glyoxal-containing cross-linking agent is in the range of 0.1 to 5.0% by weight, based on the weight of the starch, wherein the glyoxal-containing cross-linking agent preferably is added in a compression zone of an extruder, thereby producing a starch product which comprises no nanoparticles in the range of less than 1000 nm.

Surprisingly, starch products produced according to the invention have both low viscosity and good viscosity stability and solubility. Furthermore, the starch products according to the invention contain no detectable nanoparticles, i.e. they are substantially free of starch particles with a size of less than 1000 nm. This makes them very suitable for use in adhesive formulations and coating paints. According to the invention, the particle size is preferably determined by means of dynamic light scattering (DLS), in particular as shown in the examples.

If, on the other hand, the amount of glyoxal-containing cross-linking agent is below 0.1% by weight, based on the weight of the starch, the starch product comprises a low degree of degradation and/or insufficient viscosity stability. If the amount of glyoxal-containing cross-linking agent is above 5.0% by weight, based on the weight of the starch, this leads to a deterioration in the processing properties of the starch product. If the pKa value of the acid is above 2.7, the resulting starch products have a low solubility, a high viscosity and/or a low viscosity stability.

The starch provided may be any starch, including a wax starch. The use of modified starches, for example cationized and/or hydrophobicized starches, is also possible. Preferably, the starch is selected from the group consisting of corn starch, waxy corn starch, and wheat starch, or a mixture thereof. The starch products obtained according to the invention are particularly suitable for use in adhesive formulations and coating paints.

The amount of glyoxal-containing cross-linking agent is preferably in the range of 0.1 to 2.0% by weight, preferably of 0.5 to 2.0% by weight, particularly preferably of 1.0 to 1.5% by weight, in each case based on the weight of the starch. In this range, the good viscosity and solubility properties of the starch product obtained using the method are particularly evident.

The glyoxal-containing cross-linking agent may be selected from the group comprising glyoxal and glyoxal-containing resins, or a mixture thereof. The glyoxal-containing cross-linking agent is preferably glyoxal. The starch product then comprises particularly good viscosity stability. The glyoxal-containing resin may comprise Berset 2125, Berset 2169, or a mixture thereof (both available from Bercen Chemicals, USA).

The glyoxal may be in the form of an aqueous solution containing 20 to 40% by weight of glyoxal, preferably 30 to 40% by weight of glyoxal, based on the total weight of the aqueous solution. This can increase the stability of the glyoxal. The higher the glyoxal concentration in the aqueous solution, the lower the amount of aqueous solution that must be added in order to obtain a starch product with the desired amount of glyoxal. Consequently, the lower the amount of water that must subsequently be removed in order to obtain a dry starch product, and the more energy-efficiently the starch product can be dried. A 35 to 40% by weight aqueous solution of glyoxal is particularly preferably used. As a result, a good balance can be achieved between the stability of the glyoxal and the method efficiency.

Preferably, the acid and/or the salt of the acid comprises a pKa of 2.5 or below, more preferably 2.35 or below, most preferably 2.2 or below. Furthermore, the acid and/or the salt of the acid preferably comprises a pKa value of −3 or above, more preferably of 0 or above, even more preferably of 1.2 or above, particularly preferably of 1.9 or above. The pKa value of the acid and/or salt is preferably in the range of −3 to 2.7, more preferably of 0 to 2.7, even more preferably of 1.2 to 2.5, even more preferably of 1.2 to 2.35, most preferably of 1.9 to 2.2. As a result, the viscosity and solubility properties of the starch product can be further improved.

The acid is preferably selected from the group comprising sulfuric acid (pKa value of −3), nitric acid (pKa value of −1.32), phosphoric acid (pKa value of 2.16) and a dicarboxylic acid, or a mixture thereof. The dicarboxylic acid preferably comprises oxalic acid (pKa value of 1.27) and/or maleic acid (pKa value of 1.93). The salt of the acid preferably comprises a hydrogen sulfate, in particular sodium hydrogen sulfate (pKa value of 1.96). It has been found that a starch product produced using these acids or salts comprises particularly good application properties, in particular good viscosity stability and a short curing time, when used in an adhesive formulation. On the other hand, it was found that the use of malonic acid (pKa value of 2.83), tartaric acid (pKa value of 2.93) and citric acid (pKa value of 3.13), which have a pKa value of over 2.7, leads to starch products with inadequate properties, in particular with low solubility and a comparatively high viscosity or low viscosity stability.

The amount of acid or salt is preferably in the range of 1.0 to 6.0% by weight, more preferably of 1.5 to 5.5% by weight, based on the weight of the starch. The degree of degradation of the starch is then in an optimal range, i.e. the starch is sufficiently degraded, and at the same time its stability can be maintained (also due to the presence of the glyoxal-containing cross-linking agent during co-extrusion). When an acid and a salt are co-extruded with the starch in step (b), these amounts refer to the sum of the amounts of the acid and the salt.

The acid or the salt of the acid can be solid. If a solid acid or a solid salt is used, a premix can be prepared with the starch, and this premix can then be extruded. Alternatively, the solid acid or the solid salt of the starch can be added in an extruder, in particular to a feed zone of the extruder.

Alternatively, the acid or the salt of the acid may be in an aqueous solution. The aqueous solution preferably contains 20 to 40% by weight of the acid or salt, more preferably 25 to 35% by weight, based on the total weight of the aqueous solution. The aqueous solution of the acid or salt can then be fed into the extruder, in particular into a compression zone of the extruder. Alternatively, a starch slurry comprising water and 20 to 50% by weight of starch, preferably 30 to 40% by weight of starch, may be prepared (the amount of starch is based on the total weight of the starch slurry). Acid or salt can then be added to this starch slurry until a certain pH value is reached. Preferably, the pH of the starch slurry is adjusted to 3 or below, more preferably to 2 or below, even more preferably to 1.5 or below, by adding the acid or salt. The starch acidified in this way can then be dehydrated, for example in a centrifuge. The starch can then be dried. After drying, the starch preferably comprises an amount of water of 20% by weight or below, more preferably 15% by weight or below, based on the weight of the starch, and can be used in the method according to the invention. During dewatering, part of the previously added acid or part of the previously added salt may also be removed, so that the amount of acid or salt with which the starch is co-extruded may be slightly smaller compared to an amount of acid or salt when added directly to the extruder. The amount of acid or salt can be in the range of 0.1 to 6.0% by weight, preferably of 1.0 to 6.0% by weight, more preferably of 1.5 to 5.5% by weight, based on the weight of the starch.

Preferably, a viscosity stabilizer is added to the starch during the co-extrusion in step (b). As a result, the extrudability of the starch and the viscosity properties of the starch product can be further improved. The viscosity stabilizer preferably comprises a fatty alcohol. A fatty alcohol is understood to be an aliphatic, monohydric alcohol, preferably a primary alcohol. The fatty alcohol preferably contains 10 to 20 carbon atoms per molecule, more preferably 14 to 18, in particular 16. Such fatty alcohols can easily be mixed and co-extruded with the starch, the glyoxal-containing cross-linking agent and the acid or salt.

The viscosity stabilizer is preferably added in an amount of 0.1 to 1.5% by weight, more preferably 0.3 to 1.3% by weight, even more preferably 0.5 to 1% by weight, based on the weight of the starch. This can further improve the homogeneity of the starch product.

If a viscosity stabilizer is added to the starch, the amount of glyoxal-containing cross-linking agent is preferably in the range of 0.2 to 0.7% by weight, more preferably of 0.4 to 0.6% by weight, based on the weight of the starch. This allows the stabilization of the viscosity of the starch during co-extrusion to be optimized. However, the amount of glyoxal-containing cross-linking agent can also be above this preferred range and process parameters can be adjusted during extrusion, such as the rotational speed and/or the temperature in the extruder.

In the co-extrusion in step (b), on the one hand, at least some of the functional groups, in particular hydroxyl groups, of the starch are hydrolyzed in the presence of the acid or the salt, whereby the starch is at least partially degraded (i.e. destructured). On the other hand, at least some of the functional groups of the starch react with the glyoxal-containing cross-linking agent, thereby increasing the cross-linking density and/or the degree of branching of the starch. Accordingly, during the extrusion of the starch product according to the invention, a comparatively high specific mechanical energy can be introduced in order to produce a homogeneous starch product.

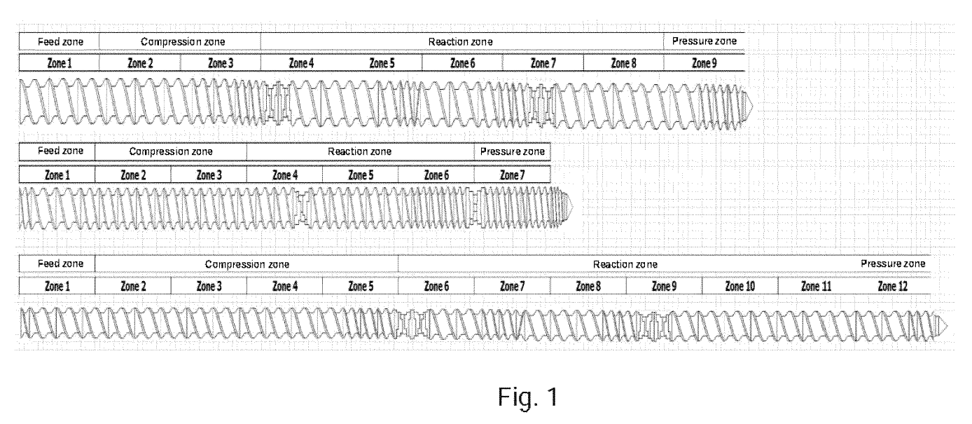

A screw extruder, as is preferably used in the method according to the invention, comprises an extruder screw and is generally divided into three zones, which perform different tasks (see also: FIG. 1). The so-called feed zone is located in the rear area of the screw cylinder. In this, the material to be extruded, which is present, for example, as a solid in the form of granules or powder, is fed via a funnel (“feeding”). The material is conveyed further by the rotation of the screw. This is followed by the compression zone, in which the material is further compressed by the reduced flight depth of the screw and thus the pressure necessary for the discharge in the tool is built up. In the subsequent reaction zone, the starch gelatinizes and any chemical reactions occur. Finally, the discharge zone or metering zone ensures a homogeneous material flow to the tool.

There are extruders with one, two or more worm shafts. The conveying and pressure build-up in the single-screw and (co-rotating) twin-screw extruder are caused by the friction of the mass rotating with the screw on the stationary housing wall (cylinder) (“friction conveying”). The mass thus remaining in rotation is pushed by the helical screw flights to the outlet nozzle. In the counter-rotating twin-screw extruder, the principle of forced conveyance predominates.

Twin-screw extruders are preferably used in the method according to the invention. For example, in the case of a co-rotating twin-screw extruder, the screws rotate in the same direction of rotation, while in the case of a counter-rotating twin-screw extruder, the screws rotate in the opposite direction of rotation. The screws may be arranged parallel or conical. Since the interaction between the screws is particularly narrow and the tendency to wear is correspondingly higher, they must meet the highest quality criteria in terms of strength and hardness.

The co-extrusion according to the invention can be carried out in a twin-screw extruder. This allows a homogeneous starch product to be obtained. The (possibly acidified) starch can be added in a feed zone of the extruder. If no acid or salt has yet been added, the addition can take place in the extruder, as described above.

In step (b), the temperature in the extruder discharge zone is preferably in the range of 100 to 180 °C, more preferably of 120 to 150 °C, even more preferably of 135 to 145 °C. The temperature is preferably increased gradually from the feed zone to the discharge zone. In the feed zone itself, the temperature can be in the range of 20 to 30 °C. This also allows good plasticization and mixing to be achieved.

During co-extrusion, 90% by weight or more of the glyoxal-containing cross-linking agent may react with the starch, preferably 95% by weight or more, more preferably 99% by weight or more, based on the weight of the starch. The high yield of the reaction of the starch with the glyoxal-containing cross-linking agent according to the invention can be determined by an exhaust air analysis of the vapors exiting the extruder. If the mass temperature in the extruder during co-extrusion exceeds the boiling point of the glyoxal-containing cross-linking agent, the result is that an unreacted glyoxal-containing cross-linking agent evaporates. For example, a 40% by weight aqueous solution of glyoxal has a boiling point of 104 °C. A mass temperature of 104 °C can be reached or exceeded in the method alone due to the preset temperature (which can increase even further due to shearing). Surprisingly, according to the invention, the glyoxal-containing cross-linking agent is nevertheless not detectable in the exhaust air, which indicates a substantially complete reaction with the starch. Thus, the method according to the invention can be carried out efficiently and in an environmentally friendly manner.

The method may comprise a further step (c): Drying the starch product. As a result, the starch product can be made harder and/or more brittle, which can facilitate further processing, in particular grinding. A dryer, preferably a fluidized bed dryer, may be used to dry the starch product. This allows the starch product to be dried well without causing thermal damage.

After drying in step (c), the starch product can be ground. As a result, the starch product can be made storable and ready for sale. In this form, it can also be used well for the production of adhesive formulations or coating paints. Preferably, the starch product is ground to a powder with a d₅₀ particle size of 200 to 400 μm, more preferably of 250 to 350 μm. The starch product can then easily be mixed into a formulation, which is advantageous for the production of adhesive formulations or coating paints. The d₅₀ particle sizes specified in this paragraph and below are determined according to the ISO 8130-13:2019 standard.

The invention further relates to a starch product obtainable by the method according to the invention and comprising an amount of the glyoxal-containing cross-linking agent in the range of 0.1 to 5.0% by weight, preferably of 0.2 to 2.0% by weight, more preferably of 0.5 to 2.0% by weight, even more preferably of 1.0 to 1.5% by weight, based on the total weight of the starch product. Such a starch product comprises both low viscosity and good viscosity stability and solubility.

The starch product preferably comprises an amount of the acid or salt in the range of 0.3 to 6.0% by weight, more preferably of 1.0 to 5.5% by weight, based on the total weight of the starch product. If the starch product contains an acid and a salt, these amounts refer to the sum of the amounts of the acid and the salt.

The starch product preferably comprises a solubility of 70% or above, more preferably of 80% or above, even more preferably of 85% or above, particularly preferably of 90% or above. This may facilitate the production of coating paints or adhesive formulations in which the starch product is used. The solubility data of this paragraph and the following are determined according to method 2 of this description.

The starch product preferably comprises a viscosity of 5000 mPas or below, more preferably of 2500 mPas or below, even more preferably of 2000 mPas or below, even more preferably of 600 mPas or below, particularly preferably in the range of 100 to 600 mPas. Lower viscosity can facilitate the production of coating paints or adhesive formulations. From an application point of view, a low viscosity can also bring advantages, since the application of such coating paints or adhesive formulations can then easily be carried out. The viscosity of the starch product for use in coating paints, in particular paper coating paints, is preferably 2000 mPas or below (for 25% by weight of the starch product in water). Furthermore, the viscosity of the starch product for use for adhesives is preferably 5000 mPas or below (for 50% by weight starch product in water). The viscosity data of this paragraph and the following are determined according to method 1 of this description.

The starch product preferably comprises a viscosity stability of 2.1 or below, more preferably of 1.4 or below, even more preferably of 1.15 or below, particularly preferably of 0.96 or below. This means that the viscosity changes only slightly or not significantly in the period from 24 h to 168 h after the production of the starch product. The starch product then has a good storage stability. The information on the viscosity stability of this paragraph and the following is determined according to method 1 of this description.

The starch product preferably comprises a d₅₀ particle size of 200 to 400 m, more preferably of 250 to 350 m. This can result in easy miscibility of the starch product, which is advantageous for the production of adhesive formulations or coating paints.

The invention further relates to a coating paint comprising the starch product according to the invention in an amount of 0.5 to 14.0% by weight, preferably 1.0 to 8.0% by weight, based on the total weight of the coating paint. Such a coating paint is easy to produce due to the good viscosity and solubility properties of the starch product and has good application properties.

The invention further relates to an adhesive formulation comprising the starch product according to the invention in an amount of 5.0 to 65.0% by weight, preferably 10.0 to 50.0% by weight, based on the total weight of the adhesive formulation. Such an adhesive formulation is easy to produce due to the good viscosity and solubility properties of the starch product and has good application properties.

A curing time of the adhesive formulation is preferably 70 sec or less, preferably 60 sec or less, determined according to method 3. As a result, sufficient adhesive strength and stability can be ensured quickly.

The adhesive formulation preferably comprises a water content of 40% by weight or below, preferably of 35% by weight or below, based on the total weight of the adhesive formulation. Accordingly, the introduction of water into the material to be bonded (e.g. paper) and thus the subsequent drying time can be reduced.

The use of the starch product according to the invention in a coating paint or an adhesive formulation is also disclosed.

All % data in this description are in percent by weight (% by weight), unless expressly stated otherwise.

The invention relates in particular to the following embodiments:
1. A method for producing a starch product comprising the steps of:
(a) providing a starch, and
(b) co-extruding the starch with (i) an acid and/or a salt of an acid, and (ii) a glyoxal-containing cross-linking agent to obtain a starch product,
wherein the acid or salt of the acid comprises a pKa of 2.7 or below, and
wherein the amount of glyoxal-containing cross-linking agent is in the range of 0.1 to 5.0% by weight, based on the weight of the starch.
2. The method according to embodiment 1, wherein the starch is selected from the group comprising corn starch, waxy corn starch, and wheat starch, or a mixture thereof.
3. The method according to embodiment 1 or 2, wherein the amount of glyoxal-containing cross-linking agent is in the range of 0.2 to 2.0% by weight, preferably 0.5 to 2.0% by weight, more preferably 1.0 to 1.5% by weight, based on the weight of the starch.
4. The method according to any of embodiments 1 to 3, wherein the glyoxal-containing cross-linking agent is selected from the group comprising glyoxal and glyoxal-containing resins, or a mixture thereof, preferably glyoxal.
5. The method according to embodiment 4, wherein the glyoxal is in aqueous solution, wherein the aqueous solution contains 20 to 40% by weight of glyoxal, preferably 30 to 40% by weight, more preferably 35 to 40% by weight, based on the total weight of the aqueous solution.
6. The method according to any of embodiments 1 to 5, wherein the acid and/or salt comprises a pKa of 2.5 or below, preferably 2.35 or below, more preferably 2.2 or below; and/or wherein the acid and/or salt comprises a pKa of −3 or above, more preferably 0 or above, more preferably 1.2 or above, most preferably 1.9 or above; wherein the pKa of the acid and/or salt is preferably in the range of −3 to 2.7, more preferably 0 to 2.7, more preferably 1.2 to 2.5, more preferably 1.2 to 2.35, most preferably 1.9 to 2.2.
7. The method according to any one of embodiments 1 to 6, wherein the acid is selected from the group comprising sulfuric acid, nitric acid, phosphoric acid, and a dicarboxylic acid, or a mixture thereof.
8. The method according to embodiment 7, wherein the dicarboxylic acid comprises oxalic acid and/or maleic acid.
9. The method according to any one of embodiments 1 to 8, wherein the salt comprises a hydrogen sulfate.
10. The method according to embodiment 9, wherein the salt comprises sodium hydrogen sulfate.
11. The method according to any one of embodiments 1 to 10, wherein the amount of the acid and/or the salt is in the range of 0.1 to 6.0% by weight, preferably of 1.0 to 6.0% by weight, more preferably of 1.5 to 5.5% by weight, based on the weight of the starch.
12. The method according to any of embodiments 1 to 11, wherein the acid or salt is solid, preferably wherein prior to step (b), the starch is mixed with the acid or salt to obtain a premix.
13. The method according to any of embodiments 1 to 11, wherein the acid or salt is solid, and wherein the acid or salt is added to the starch in a feed zone of an extruder.
14. The method according to any one of embodiments 1 to 11, wherein the acid or salt is in an aqueous solution, wherein an amount of the acid or salt in the aqueous solution is preferably in the range of 20 to 40% by weight, more preferably 25 to 35% by weight, based on the total weight of the aqueous solution.
15. The method according to embodiment 14, wherein the acid or salt is added to the starch in a compression zone of the extruder, wherein the extruder is preferably a screw extruder or a (co-rotating) twin-screw extruder.
16. The method according to embodiment 14, wherein the acid or the salt is added prior to step (a) to a starch slurry containing 20 to 50% by weight of starch (based on the total weight of the starch slurry), preferably until a pH of the starch slurry of 3 or below, more preferably 2 or below, particularly preferably 1.5 or below, is reached.
17. The method according to any one of embodiments 1 to 16, wherein the starch in step (b) is additionally co-extruded with a viscosity stabilizer.
18. The method according to embodiment 17, wherein the viscosity stabilizer comprises a fatty alcohol.
19. The method according to embodiment 18, wherein the fatty alcohol contains 10 to 20 carbon atoms per molecule, preferably 14 to 18, in particular 16.
20. The method according to any of embodiments 17 to 19, wherein the viscosity stabilizer is added in an amount of 0.1 to 1.5% by weight, more preferably 0.3 to 1.3% by weight, even more preferably 0.5 to 1% by weight, based on the weight of the starch.
21. The method according to any one of embodiments 1 to 20, wherein the co-extrusion in step (b) is performed in a twin-screw extruder.
22. The method according to any one of embodiments 1 to 21, wherein the starch is added in a feed zone of an extruder, wherein the extruder is preferably a screw extruder or a (co-rotating) twin-screw extruder.
23. The method according to any one of embodiments 1 to 22, wherein the glyoxal-containing cross-linking agent, in particular a glyoxal solution, is added in a compression zone of an extruder, wherein the extruder is preferably a screw extruder or a (co-rotating) twin-screw extruder.
24. The method according to any of embodiments 1 to 23, wherein in step (b), the temperature in the discharge zone of an extruder is in the range of 100 to 180 °C, preferably of 120 to 150 °C, more preferably of 135 to 145 °C.
25. The method according to any one of embodiments 1 to 24, further comprising step (c): Drying the starch product.
26. The method according to embodiment 25, wherein the drying of the starch product in step (c) is performed in a fluidized bed dryer.
27. The method according to embodiment 25 or 26, wherein the starch product is ground after step (c), preferably to a powder having a d₅₀ particle size of 200 to 400 μm, more preferably of 250 to 350 m.
28. Starch product obtainable by a method according to any of embodiments 1 to 27, wherein the starch product comprises an amount of the glyoxal-containing cross-linking agent in the range of 0.1 to 5.0% by weight, preferably 0.2 to 2.0% by weight, more preferably 0.5 to 2.0% by weight, even more preferably 1.0 to 1.5% by weight, based on the total weight of the starch product.
29. The starch product of embodiment 28, wherein the starch product comprises an amount of the acid and/or salt of the acid in the range of 0.3 to 6.0% by weight, preferably of 1.0 to 5.5% by weight, based on the total weight of the starch product.
30. The starch product according to embodiment 28 or 29, wherein the starch product comprises a solubility of 70% or above, more preferably 80% or above, even more preferably 85% or above, most preferably 90% or above.
31. The starch product according to any of embodiments 28 to 30, wherein the starch product comprises a viscosity of 5000 mPas or below, preferably of 2500 mPas or below, more preferably of 2000 mPas or below, even more preferably of 600 mPas or below, most preferably in the range of 100 to 600 mPas.
32. The starch product according to any of embodiments 28 to 31, wherein the starch product comprises a viscosity stability of 2.1 or below, more preferably 1.4 or below, even more preferably 1.15 or below, most preferably 0.96 or below.
33. The starch product according to any of embodiments 28 to 32, wherein the starch product comprises a d₅₀ particle size of 200 to 400 m, more preferably of 250 to 350 m.
34. Coating paint comprising a starch product according to any of embodiments 28 to 33 in an amount of 0.5 to 14.0% by weight, preferably 1.0 to 8.0% by weight, based on the total weight of the coating paint.
35. An adhesive formulation comprising a starch product according to any of embodiments 28 to 33 in an amount of 5.0 to 65.0% by weight, preferably 10.0 to 50.0% by weight, based on the total weight of the adhesive formulation.
36. An adhesive formulation according to embodiment 35, wherein a curing time of the adhesive formulation is 70 sec or less, preferably 60 sec or less, determined according to method 3.
37. The adhesive formulation according to embodiment 35 or 36, wherein the adhesive formulation comprises a water content of 40% by weight or below, preferably of 35% by weight or below, based on the total weight of the adhesive formulation.
38. Use of a starch product according to any of embodiments 28 to 33 in a coating paint or an adhesive formulation.

The invention is illustrated in more detail in the following examples and the drawing figure, but of course, without being limited thereto.

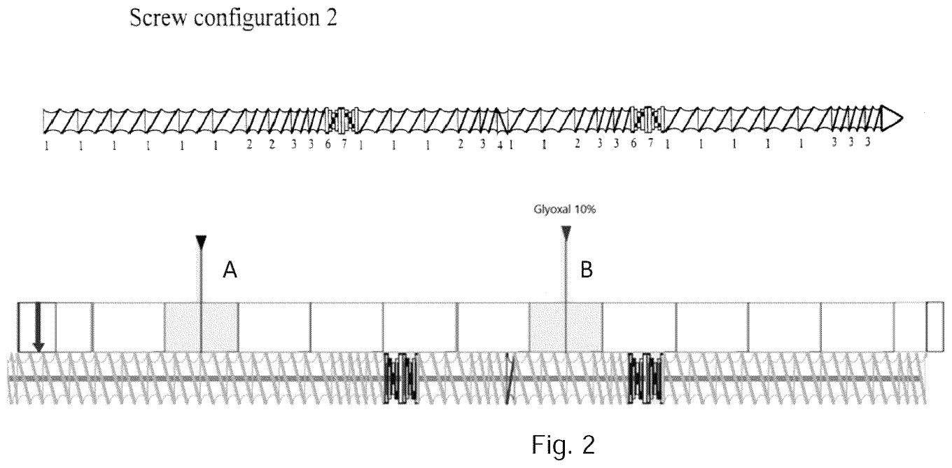

FIG. 1 and FIG. 2 show schematic illustrations of the structures of slightly different screw configurations: at the top is the “Screw configuration 2” from WO 00/69916 A1, in the middle is the screw configuration used in the Theyson TSK 30/28D (used in the present examples) and at the bottom is Coperion ZSK26MC18, with an extended reaction zone. The compression zone is the area after the feed zone and before the zones with the first shear elements. Here, there is still no reaction or gelling of the starch. In the subsequent reaction zone, the starch is gelatinised with the help of kneading, mix and shear elements, and reactions such as degradation and cross-linking take place. In the reaction zone (zone 5), glyoxal is also added in accordance with WO 00/69916 A1 (FIG. 2B). The dosage of glyoxal according to the invention preferably takes place in the compression zones before the gelatinization of the starch (FIG. 2A), since this leads to a starch product which—in contrast to the method according to WO 00/69916 A1—has no nanoparticles in the range of less than 1000 nm.

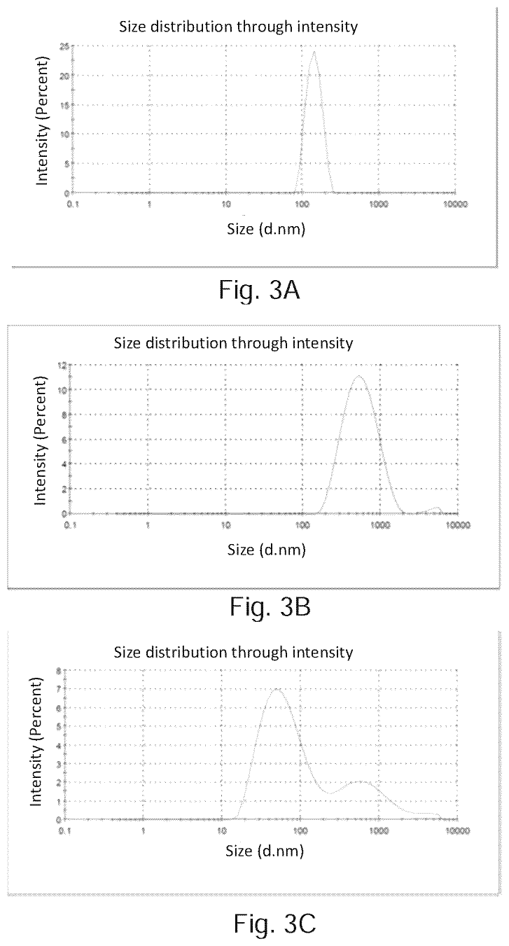

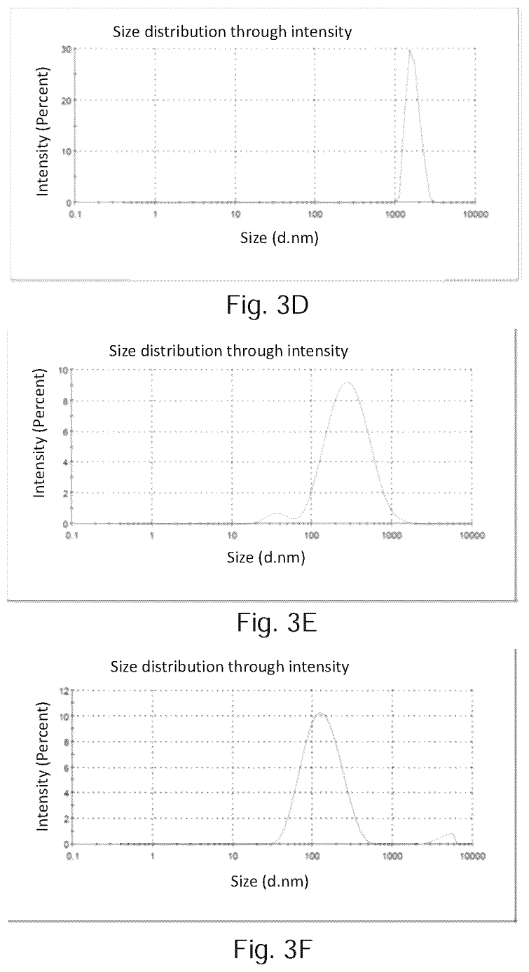

FIG. 3 shows the DLS measurement of SBR latex 10%: Dilution 10 μl to 1 mL (A); the DLS measurement of starch latex: dilution 10 μl to 1 mL (B); the DLS measurement of product 1: dilution 10 μl to 1 mL (C); the DLS measurement of product 2: dilution 10 μl to 1 mL (D); the DLS measurement of extruded native WMS with maleic acid: dilution 10 μl to 1 mL (E); the DLS measurement of extruded native WMS: dilution 10 μl to 1 mL (F).

### EXAMPLES

### Example 1—Production and Analysis of Starch Products

The 20 tests listed in Table 1 were carried out. Wheat starch (WS), corn starch (MS) and waxy corn starch (WMS) were used for the experiments. Sodium hydrogen sulfate (NaHSO₄), oxalic acid, sulfuric acid (H₂SO₄), phosphoric acid (H₃PO₄), maleic acid, citric acid and tartaric acid were used as acids or salts of acids. The data in % by weight given in Table 1 relate to the weight of the starch.

In tests 1-9, 14 and 16-20, the acid or salt was added to the starch in solid form and a premix was prepared in a drum mixer (Zimmermann Rhönradbau und Rohrbiegefertigungs GmbH, Germany) to obtain an acidified starch.

In tests 10, 11 and 15, starch slurries containing water and 35% by weight of starch were first prepared in a large plastic stirred container. The pH of these starch slurries was then adjusted to the value specified in Table 1 by adding the acid. The starch slurries were then dewatered in a centrifuge and dried using a flash dryer (Anhydro Spin Flash Dryer, SPX Flow Technology Germany GmbH, Germany). After drying, the acidified starches still contained about 12% by weight of water.

In tests 12 and 13, the acid (aqueous solution of phosphoric acid) was added directly into the compression zone of the extruder.

Experiments 19 and 20 correspond to Example 1 on pages 19-20 of WO 2016/097149 A1, with 14.4% by weight of glycerol being added in experiment 19 (based on the total weight of the starch product) in order to reproduce Example 1 of this document identically, while no glycerol was contained in experiment 20 in order to enable better comparability with the other experiments.

A twin-screw extruder (TSK-30/28D, Theysohn Extrusionstechnik GmbH, Germany) was used for extrusion. The (possibly acidified) starch was added to the extruder in the feed zone. In the compression zone, water and a 40% by weight aqueous solution of glyoxal were added in. Aqueous solutions of acids (in experiments 12 and 13) were also added in the compression zone. So much water was added that the solids content was 83% by weight (based on the total weight of the mixture to be extruded). The addition of water can reduce the shear during extrusion and thus the degradation of the starch products. The following parameters were used in the extrusion: Performance: 10 kg/h; Rotational speed: 300 rpm; Nozzle geometry: 2×3.5 mm; Temperature in the individual zones (from the feed zone to the discharge zone): 20/30/40/50/80/100/120/140 °C.

The extruded starch products were dried in a fluidized bed dryer (Jöst GmbH+Co. KG, Germany) and ground with a fine impact mill (Ultraplex UPZ 100, Hosokawa Alpine, Germany) equipped with a sieve insert with 1 mm mesh width to a powder with a d₅₀ particle size of approx. 300 m.

The viscosity, viscosity stability and solubility of the starch products were then determined using methods 1 and 2 given in this description. The results are listed in Table 1. In tests Nos. 1-8 and 10-15, starch products according to the invention having a low viscosity, good viscosity stability and good solubility were obtained. The concentrations that the starch products had when determining the viscosity are also given in Table 1.

It can be clearly seen from Table 1 that with acids that have a pKa value of 2.83 or above, the required properties are not achieved (Experiments No. 16-20). Above all, the solubility of these starch products is comparatively low and is 60% or below. Furthermore, experiments 16-19 have a comparatively high viscosity, while the viscosity stability of experiment 20 is comparatively low.

Furthermore, it can be seen that the starch product to which no glyoxal has been added (Experiment No. 9) already comprises a very high viscosity immediately after preparation, which makes it unsuitable for use in adhesive formulations or coating paints. The viscosity was already 10,000 mPas after 24 h and increased so much in the course of the week that the viscosity after 168 h was not determinable, and consequently also not the viscosity stability.

TABLE 1
Starting components for the production of starch products, as well as viscosity
(time t = 0), viscosity stability (168 h/24 h) and solubility of starch products

| | | Acid or salt | | | Amount of | | Viscosity | | |
|---|---|---|---|---|---|---|---|---|---|
| | | | Amount | | glyoxal | | (mPas) | | |
| | | | (% by | | (% by | Concentration | | 168 h/ | Solubility |
| No. | Starch¹ | Type | weight) | pKa | weight)⁴ | (%) | t = 0 | 24 h | (%) |
| 1 | WS | NaHSO₄ | 2.0 | 1.96 | 2.0 | 25 | 428 | 0.96 | 96 |
| 2 | MS | NaHSO₄ | 2.0 | 1.96 | 2.0 | 25 | 209 | 0.80 | 94 |
| 3 | WMS | NaHSO₄ | 2.0 | 1.96 | 2.0 | 50 | 2220 | 1.13 | 100 |
| 4 | WS | NaHSO₄ | 5.0 | 1.96 | 2.0 | 25 | 283 | 0.80 | 93 |
| 5 | WS | Oxalic | 2.0 | 1.27 | 2.0 | 50 | 2244 | 1.00 | 99 |
| | | acid | | | | | | | |
| 6 | WS | Oxalic | 2.0 | 1.27 | 2.0 | 25 | <100 | 1.00 | 99 |
| | | acid | | | | | | | |
| 7 | WS | Oxalic | 2.0 | 1.27 | 1.0 | 25 | 124 | 1.30 | 92 |
| | | acid | | | | | | | |
| 8 | WS | Oxalic | 2.0 | 1.27 | 0.4 | 25 | 430 | 1.9 | 86 |
| | | acid | | | | | | | |
| 9 | WS | Oxalic | 2.0 | 1.27 | 0 | 25 | 5290 | n.d.⁵ | 84 |
| | | acid | | | | | | | |
| 10 | WS | H₂SO₄ | pH 2.0² | −3.00 | 2.0 | 25 | 266 | 1.30 | 96 |
| 11 | WS | H₂SO₄ | pH 1.3² | −3.00 | 2.0 | 50 | 1440 | 1.10 | 96 |
| 12 | WS | H₃PO₄ | 1.5³ | 2.16 | 2.0 | 25 | 535 | 1.22 | 93 |
| 13 | WMS | H₃PO₄ | 1.5³ | 2.16 | 2.0 | 50 | 1900 | 1.90 | 100 |
| 14 | WS | Maleic | 2.0 | 1.93 | 2.0 | 25 | 195 | 0.90 | 87 |
| | | acid | | | | | | | |
| 15 | WS | Maleic | pH 1.4² | 1.93 | 2.0 | 25 | 120 | 1.11 | 92 |
| | | acid | | | | | | | |
| 16 | WS | Malonic | 2.0 | 2.83 | 2.0 | 25 | 11240 | 1.00 | 41 |
| | | acid | | | | | | | |
| 17 | WS | Citric | 2.0 | 3.13 | 2.0 | 25 | 2308 | 1.00 | 48 |
| | | acid | | | | | | | |
| 18 | WS | Tartaric | 2.0 | 2.93 | 2.0 | 25 | 6010 | 1.00 | 60 |
| | | acid | | | | | | | |
| 19 | MS | Citric | 1.8 | 3.13 | 1.4 | 25 | 6000 | 1.30 | 51 |
| | | acid | | | | | | | |
| 20 | MS | Citric | 1.8 | 3.13 | 1.4 | 25 | 328 | 2.42 | 34 |
| | | acid | | | | | | | |

¹WS = waxy starch, MS = corn starch, WMS = waxy corn starch
²acid was added until the pH reached the specified value
³corresponds to 5% by weight of a 30% by weight aqueous solution of phosphoric acid
⁴the stated glyoxal amounts of 0.4 to 2.0% by weight correspond to 1.0 to 5.0% by weight of a 40% by weight aqueous solution of glyoxal
⁵n.d. . . . not determinable

### Example 2—Production and Analysis of Coating Paints

Some of the starch products prepared in Example 1 were used for the preparation of coating paints. Reference coating paints were produced using commercially available starch products. Amitrocoat 8903 (Agrana, Austria) and iCoat (Cargill, USA) were used.

Calcium carbonate (Omya Hydrocarb 90, Omya, Switzerland) and the majority of the required deionized water were added first and the respective starch product was stirred with a turbine stirrer at 1000 rpm for 10 min. After addition of latex (Styronal D 809, BASF, Germany), the mixture was stirred at 1000 rpm for a further 3 minutes. During stirring, 0.5 M NaOH was added dropwise until a pH of 8.5 was reached. Then the remaining deionized water was added. 350 g of coating paint were prepared per batch. The compositions and properties of the coating paints can be seen from Table 3.

After measuring the viscosity (according to method 1), a small amount of a thickener Sterocoll FS (BASF, Germany), which is an aqueous dispersion of an acrylic copolymer, was pipetted in with stirring at a viscosity of below 1000 mPas. It was then stirred for 10 minutes, the viscosity was then measured again and, if necessary, more Sterocoll was added until a viscosity of 1000 mPas or more was reached. The viscosity was in the range of 1024 to 2164 mPas for all coating paints investigated.

A defined amount of the coating paint was filtered through a sieve with a pore size of m. The residue was dried at 100 °C and then weighed. The values were in the ppm range, as can be seen from Table 2.

The determination of the high shear viscosity at a shear rate of 50,000 s⁻¹ and a temperature of 25 °C was carried out with the Physica MCR 301 rheometer (Anton Paar, Austria) with a special cylinder cup measuring system (C-CC 48.55/ST/CUST1 from Anton Paar, Austria) with a gap distance of 100 m by measuring the viscosity as a function of the shear rate, which was varied from 100 s⁻¹ to 50,000 s⁻¹. The results can be found in Table 2.

TABLE 2
Compositions and properties of coating paints

| | | | | | | | Amitrocoat |
|---|---|---|---|---|---|---|---|
| Test No. | 1 | 2 | 4 | 10 | 15 | iCoat | 8903 |

Compositions

| | | | | | | | |
|---|---|---|---|---|---|---|---|
| Calcium carbonate | 100 | 100 | 100 | 100 | 100 | 100 | 100 |
| Latex (pph)¹ | 4.5 | 4.5 | 4.5 | 4.5 | 4.5 | 4.5 | 4.5 |
| Starch (pph)¹ | 4.5 | 4.5 | 4.5 | 4.5 | 4.5 | 4.5 | 4.5 |
| Thickener (pph)¹ | 0.48 | 0.37 | 0.07 | 1.88 | 0.80 | 0.59 | 0 |

Properties

| | | | | | | | |
|---|---|---|---|---|---|---|---|
| Solids content | 70.10 | 70.03 | 70.09 | 69.94 | 70.01 | 70.01 | 70.02 |
| (% by weight) | | | | | | | |
| pH value | 8.5 | 8.5 | 8.5 | 8.5 | 8.5 | 8.5 | 8.5 |
| Temperature (°C) | 24 | 25 | 27 | 25 | 26 | 24 | 25 |
| Viscosity (mPas) | 1132 | 1032 | 1024 | 1132 | 1268 | 1040 | 2164 |
| Residue (ppm) | 80 | 92 | 83 | 20 | 69 | 12 | 122 |
| High shear viscosity | 50.8 | 43.2 | 33.0 | 37.4 | 36.4 | 49.9 | 47.8 |
| at 50,000 s⁻¹ (mPas) | | | | | | | |

¹pph . . . parts per hundred

### Example 3—Preparation and Analysis of Adhesive Formulations

Adhesive formulations comprising starch, calcium carbonate as filler (Omyacarb 2, Omya, Austria) and a biocide (Acticide MBS, Thor, Germany) were prepared. For this purpose, all components were mixed with deionized water, the pH was adjusted to about 10 with 30% by weight NaOH and stirred with a toothed disc stirrer at 3000 rpm for 30 minutes. The composition was chosen so that the viscosity of the adhesives is in a comparable range between 1000 and 3000 mPas (Brookfield viscosity, 100 rpm, 25 °C). For reference, Amitrocoll C57 and dextrin 20,921 (both from Agrana, Austria) were used. The compositions of the adhesive formulations can be found in Table 3.

The curing time of the adhesive formulations was determined using method 3, with two layer thicknesses (60 and 120 m) being tested. As can be seen from Table 3, a much smaller amount of water needs to be added to the adhesive formulations according to the invention than Amitrocoll C57 in order to adjust the viscosity to a value in the range indicated above. The water content in the adhesive formulations containing the starch products according to the invention from experiments 3 and 13 is 31% by weight, while in the adhesive formulation containing Amitrocoll C57 it is 46.7% by weight (in each case based on the total weight of the adhesive formulation). As a result, the introduction of water into the material to be bonded (e.g. paper) and, accordingly, the drying time can be reduced. As can also be seen from Table 3, the adhesive formulations according to the invention have a significantly shorter curing time than dextrin 20,921.

TABLE 3
Compositions and properties of adhesive formulations

| | | References | | Invention | |
|---|---|---|---|---|---|
| | | Amitrocoll | Dextrin | Experiment | Experiment |
| | | C57 | 20,921 | No. 3 | No. 13 |
| Starch | (g) | 60 | 60 | 60 | 60 |
| Calcium | (g) | 140 | 140 | 140 | 140 |
| carbonate | | | | | |
| Water | (g) | 175 | 90 | 90 | 90 |
| Biocide | (g) | 0.1 | 0.1 | 0.1 | 0.1 |
| Curing | 60 μm | 37 | 80 | 42 | 43 |
| time (s) | 120 μm | 75 | >150 | 60 | 63 |

### Example 4—Comparative Example: Extrusion According to the Invention (Addition of the Glyoxal-Containing Cross-Linking Agent, in Particular Glyoxal in a Compression Zone) Compared to Extrusion According to WO 00/69916 A1 (Addition of Glyoxal after the Compression Zone)

FIG. 1 and FIG. 2 show schematic illustrations of the structures of slightly different screw configurations: at the top is the “Screw configuration 2” from WO 00/69916 A1, in the middle is the screw configuration used in the Theyson TSK 30/28D (used in the above examples) and at the bottom is Coperion ZSK26MC18, with an extended reaction zone. In the compression zone (the area after the feed zone and before the zones with the first shear elements), there is still no reactions or gelling of the starch. In the subsequent reaction zone, the starch is gelatinized with the help of kneading, mix and shear elements, and reactions such as degradation and cross-linking take place. In the reaction zone (“zone 5”), glyoxal is also added in accordance with WO 00/69916 A1 (FIG. 2B). The dosage of glyoxal according to the invention preferably takes place in the compression zones before the gelatinization of the starch (FIG. 2A), since this leads to a starch product which—in contrast to the method according to WO 00/69916 A1—has no nanoparticles in the range of less than 1000 nm.

| | WO | | |
|---|---|---|---|
| | 00/69916 | Agrana Research | |
| | Bersdorff | Coperion | Theyson |
| Extruder | ZE40 | ZSK26MC18 | TSK 30/28D |
| Product | | Product 1 | Product 2 |
| Zones [Number] | 9 | 12 | 7 |
| L/D | 38 | 48 | 28 |
| Glyoxal dosing at D | 22 | 32 | 8 |
| Compression zone at | (Zone 5) | (Zone 8) | (Zone 2) |
| D | 2- 3 | 2 - 5 | 2 - 3 |

Application WO 00/69916 A1 describes the production of nanoparticles via a reactive extrusion process using glyoxal as a cross-linking agent. Example 10 of the application WO 00/69916 A1 also describes the use of maleic acid, wherein a 10% glyoxal solution in water was introduced in the fifth zone (“22D”) of the extruder described therein with a “screw configuration 2” (cf. also FIG. 1). In contrast to the production of nanoparticles described in WO 00/69916 A1, the production process according to the invention avoids the formation of nanoparticles by adding the glyoxal-containing cross-linking agent in a compression zone.

To illustrate these differences, Example 10 of WO 00/69916 A1 was reproduced below. The extruder used was a twin-screw machine of the type ZSK26 (26 mm screw diameter, 48D), which substantially corresponds to the (longer) extruder Bestorff ZE40 used in WO 00/69916 A1. The structure consists of 12 zones (separate housings) and the system is operated by means of a 36.9 kW motor which allows a maximum speed of 1200 revolutions per minute. Raw materials are introduced into the extruder via dosing units that are integrated into the control system (2×gravimetric for solids, 1×gravimetric for liquids, 2×volumetric for liquids).

Glyoxal was dosed into the 8^{th} zone (32D) due to the available dosing options. The screw configuration has been adapted to the longer extruder.

### Analyses of the Product Samples:

The solutions were prepared as indicated (latex preparation 1) and the viscosities were determined. Contrary to the description in WO 00/69916 A1, no viscosity could be measured at a concentration of 35%.

| | | | | Product |
|---|---|---|---|---|
| | | Product Rework | | according to |
| | | WO 00/69916 A1 | | the invention |
| | | Product 1 | | Product 2 |
| | | 10% | 35% | 35% |
| RV | 100 | 55 | Not measurable | 490 |
| Brookfield | 50 | 40 | | 700 |
| 2 h [mPas] | 20 | 24 | | 1380 |
| | Temp | 24 | | 23 |
| | pH | 2.7 | | 1.4 |
| Solubility | [%] | 99 | | 99 |

Determination of Particle Sizes after Dispersion

To measure the nanoparticles, 10% solutions of the starches were prepared and centrifuged for 10 min at 3000 rpm and filtered with a 1 m filter to separate coarse particles. As a reference, this was also carried out with a styrene-butadiene latex (SBR latex).

The DLS measurements were performed on the following device: The Zetasizer Nano ZSP from Malvern Pananalytical is a high-performance particle characterization system that can be used to measure:

### Particle Size and Molecule Size

Measuring range: 10 nm-10.0 m (diameter)
Measuring principle: Dynamic light scattering
Minimum sample volume: 12 μl
Sensitivity: 0.1 mg/ml (lysozyme)

The dilution from 10 μL to 1 mL was chosen in order to obtain the best possible scattering signal.

With the SBR latex (synthetic reference product), beautiful particles in the range of just over 100 nm could be measured (FIG. 3A). In the case of starch latex, the particles were also well measurable in the range of 600 nm (FIG. 3B). Nanoparticles could be detected in product 1 (experiment according to WO 00/69916 A1) (FIG. 3C). Even with extruded native waxy maize starch (with and without maleic acid and without glyoxal cross-linking agent), nanoparticles in the range of 330 nm and 150 nm were visible (FIG. 3E, FIG. 3F). In the product 2 produced according to the invention, no nanoparticles in the range of <1000 nm were measurable (FIG. 3D; in the present case, wheat starch was used, but other starches can also be used, in particular waxy maize starch, maize starch or mixtures of different starches).

### METHODS

### Method 1—Determination of Viscosity and Viscosity Stability

1 to 2 g of NaOH (5 M, about 20% by weight in water) were added first in a beaker and filled up to 187.5 g with deionized water. The starch product (prepared, for example, according to Example 1) was weighed in such an amount that the total weight was 250 g (250 g-187.5 g=62.5 g starch product; corresponds to 25% by weight starch product in water). Stirring was carried out with a toothed disc stirrer at 1500 rpm for 30 min, and the starch product was sprinkled in with stirring. The pH was adjusted to approx. 7.5 to 8.0 with NaOH (3% by weight in water). The more NaOH is required, the more NaOH should be added at the beginning to prevent excessive dilution. The paste produced in this way was then subjected to a viscosity measurement. Alternatively, the beaker can also be made up to 125 g with deionized water, and then 125 g of starch can be added (corresponds to 50% by weight of starch product in water).

The viscosity (Brookfield viscosity) was determined using a rotational viscometer (Brookfield DV-II+Pro, Brookfield, Germany) at 25 °C and a speed of 100 rpm with spindle 5 (Brookfield, Germany; spindle 1 of the rotational viscometer is suitable for low-viscosity substances and spindle 7 for high-viscosity substances). The first measurement was carried out immediately after the production of the pastes (at the time t=0), further measurements were carried out after 24 h and 168 h in order to assess the viscosity stability. The quotient of the viscosities after 168 h and 24 h was used as a measure of the viscosity stability.

### Method 2—Determination of Solubility

10 g of a starch product (prepared, for example, according to Example 1) in dry matter was stirred into deionized water in a beaker with a turbine stirrer (1500 rpm, 15 min) in order to obtain a 10% by weight solution. This was centrifuged for 10 min at 3000 rpm and the starch concentration in the supernatant was determined by means of a refractometer (PAL-1, Atago, Japan). The solubility in % is the ratio of the measured starch concentration to the initially used starch concentration of 10% by weight.

### Method 3—Determination of Adhesive Properties of Adhesive Formulations

A hand rake was placed with the desired layer thickness (60 or 120 m) on the outside of a corrugated paper (basis weight of 110 g/m²), filled with an adhesive formulation containing a starch product (preparation e.g. according to Example 3) and pulled over the corrugated paper. A strip of display cardboard (weight per unit area of 170 g/m²) was then placed with the inside on the glued corrugated paper. The folded papers were stripped off with the flat hand and stripped again on the back in the same way. The glued laminate was now slowly pulled apart piece by piece by hand (slightly jerky) until a complete fiber tear was detected. A complete fiber tear is understood to be a fiber tear that extends over the entire bond width, i.e. in a direction that is substantially perpendicular to the direction of tension. The point in time of the complete fiber tear is the point in time at which the adhesive formulation has reached a sufficient bond strength. The duration of the pulling apart until the time of the complete fiber tear is used as a measure of the curing time until such a bond strength is reached. It is given in seconds and is calculated from an average of three individual measurements. If after 150 seconds no complete fiber tear, and thus no sufficient adhesion, could be detected, the measurement was aborted.

### Method 4—Determination of Particle Size Using Dynamic Light Scattering (DLS)

To measure the nanoparticles, 10% solutions of the starches were prepared and centrifuged for 10 min at 3000 rpm and filtered with a 1 m filter to separate coarse particles. As a reference, this was also carried out with a styrene-butadiene latex (SBR latex). 1 ml of distilled water was placed in a cuvette and 10 μl of starch dispersion was pipetted in and briefly shaken.

The DLS measurements were performed on the following device: The Zetasizer Nano ZSP from Malvern Pananalytical is a high-performance particle characterization system that can be used to measure:

### Particle Size and Molecule Size

Measuring range: 10 nm-10.0 m (diameter)
Measuring principle: Dynamic light scattering
Minimum sample volume: 12 μl
Sensitivity: 0.1 mg/ml (lysozyme)

The evaluation was carried out in the program of the Zetasizer with the size distribution according to intensity.

1. A method for producing a starch product comprising the steps of:
(a) providing a starch, and
(b) co-extruding the starch with (i) an acid and/or a salt of an acid, and (ii) a glyoxal-containing cross-linking agent to obtain a starch product,
wherein the acid or salt of the acid comprises a pKa of 2.7 or below,
wherein the amount of glyoxal-containing cross-linking agent is in the range of 0.1% to 5.0% by weight, based on the weight of the starch, and
wherein the glyoxal-containing cross-linking agent is added in a compression zone of an extruder.

2. The method according to claim 1, wherein the amount of glyoxal-containing cross-linking agent is in the range of 0.5% to 2.0% by weight, based on the weight of the starch.

3. The method according to claim 1, wherein the glyoxal-containing cross-linking agent is glyoxal.

4. The method according to claim 1, wherein the acid and/or the salt comprises a pKa of 2.35 or below.

5. The method according to claim 1, wherein the amount of acid and/or salt is in the range of 1.0% to 6.0% by weight, based on the weight of the starch.

6. The method according to claim 1, wherein the acid is selected from the group comprising sulfuric acid, nitric acid, phosphoric acid and a dicarboxylic acid, or a mixture thereof.

7. The method according to claim 6, wherein the dicarboxylic acid comprises oxalic acid and/or maleic acid.

8. The method according to claim 1, wherein the starch in step (b) is additionally co-extruded with a viscosity stabilizer.

9. The method according to claim 8, wherein the viscosity stabilizer comprises a fatty alcohol, wherein the fatty alcohol contains 10 to 20 carbon atoms per molecule.

10. The method according to claim 8, wherein the viscosity stabilizer is added in an amount of 0.1% to 1.5% by weight, based on the weight of the starch.

11. A starch product obtainable by the method according to claim 1, wherein the starch product comprises an amount of the glyoxal-containing cross-linking agent in the range of 0.1% to 5.0% by weight, based on the total weight of the starch product.

12. The starch product according to claim 11, wherein the starch product comprises a viscosity stability at 25 °C of 0.96 or below.

13. The starch product according to claim 11, wherein the starch product comprises a viscosity at 25 °C of 600 mPas or below.

14. A coating colour comprising the starch product according to claim 11 in an amount of 0.5% to 14.0% by weight, based on the total weight of the coating colour.

15. An adhesive formulation comprising the starch product according to claim 11 in an amount of 5.0% to 65.0% by weight, based on the total weight of the adhesive formulation.
